(19) United States
(12) Patent Application Publication
(10) Pub. No.: US 2020/0188926 A1
(43) Pub. Date: Jun. 18, 2020

(54) METHODS AND DEVICES FOR CONTINUOUS DISINTEGRATION, DRYING AND SEPARATION OF BULK MATERIALS

(71) Applicant: Ilya Alexandrovich SEMIN, MOSCOW (RU)

(72) Inventor: Ilya Alexandrovich SEMIN, MOSCOW (RU)

(21) Appl. No.: 16/617,744

(22) PCT Filed: Nov. 14, 2017
(86) PCT No.: PCT/RU2017/000850

§ 371 Date: Nov. 27, 2019

(51) Int. Cl. B02C 7/06; B02C 7/12

(52) U.S. Cl. CPC B02C 7/06; B02C 7/12

(57) ABSTRACT

The invention relates to means for the autogenous grinding, separation and drying of various solid materials in a continuous process and can be used in many branches of industry. The technical result consists in creating a high-speed, powerful and at the same time energy-efficient, simple and reliable device and method for breaking up an initial stock and simultaneously drying particles of the ground stock. The technical result is achieved by feeding an initial stock into a grinding working area, grinding the initial stock and drying particles of the ground initial stock and discharging the ground and to a certain extent the dried particles of the initial stock outwards, with the initial stock being fed in and the dried particles of the ground stock being discharged by rotation of working flywheels.

### CROSS-REFERENCE TO RELATED APPLICATIONS

The present patent application is a National stage application for the PCT application PCT/RU2017/000850 filed Nov. 14, 2017.

### FIELD OF INVENTION

The invention relates to the devices for self-disintegration, separation and dehumidification of various solid materials in the flow and can be applied in many industries.

### BACKGROUND

A centrifugal rotary disintegrator is known in the prior art described in RU No. 2004118152 A, class V02S 13/22. This disintegrator comprises a housing with two rotors inside. The rotors are mounted on the shafts and equipped with pulleys that ensure rotor rotation in opposite directions. The disintegrator is equipped with a feed spout. Pins are attached to the rotors in a cantilevered way, which are located with concentric rows, each row of single rotor pins is located between two rows of another rotor pins. Cylindrical cups made of hard-alloy material are tightly mounted on removable pins. Disc rotors rotate in opposite directions. They feed the material to be disintegrated through a feeding port, which is supplied to the central part of the inter-rotor space. Material particles are impacted by the first row pins, acquire the speed corresponding to this row of pins by the centrifugal force and thrown onto the second row of pins coining in the opposite direction. After being impacted by the second row of fingers, they rebound from it, change their speed vector and are thrown on the third row of fingers, etc. The particles of the material to be processed are thrown away by the last row of pins from the processing zone and discharged from the working chamber through a feed port.

The disintegrator from the prior art has some drawbacks as described hereafter. Low disintegration efficiency due to dynamic loads constantly acting on rotor pins and sleeves and the abrasive wear of these elements caused thereby. An insufficient lifetime of disintegrator rotors equipped with removable pins with cylindrical removable cups tightly mounted thereupon and made of a hard-alloy material, wherein the cups are tightly mounted on each pin of two rotors. The major drawback is no guaranteed fraction of the disintegrated product, and those models where such product can be obtained need additional functions and equipment, as well as the introduction of additional classification devices into the disintegration processes, and those models that already have the classifier suffer from problems with finished product dehumidification. High wear and frequent replacements of device elements related therewith, low performance, a high specific amount of metal, high energy consumption.

### SUMMARY

The task solved by the claimed invention is to create a continuous flow process of self-disintegration, separation and dehumidification of the disintegration product within the same device (combined by mechanisms into a single assembly) to obtain a finished product with the upper controlled limit of particle sizes of the required fineness and dehumidification by counter co-impacting of streams of the air and feed mixture. The energy spent for disintegration is consumed mainly to create a gap in initial feed chunks so that it prevents any strains occurring due to compression forces. Grinding bodies are also not required. In the claimed invention, the housing parts in the working chambers act as grinding bodies by means of impact reflection of the air and feed flow.

The technical result of the proposed invention consists in creating a high-speed, powerful and energy efficient, simple, reliable device and method to disintegrate the initial feed and dehumidify the particles of the disintegrated feed. The claimed devices and method allow reducing the specific energy consumption by 90% as compared to existing modern technologies and obtaining a mill product of guaranteed fraction in the flow.

The first embodiment of this invention suggests a device for flow disintegration, dehumidification and separation of loose materials having an flow housing that comprises: two concave working flywheels comprising radial ribs on their concave surfaces, capable of counter rotation, having a gap between them, installed co-axially on a fixed hollow axis with ports to supply the initial feed or on two fixed hollow axes comprising at least one port to supply the initial feed, wherein there is a working chamber between the working surfaces of the mentioned flywheels with a space confined by the mentioned working surface where, in its turn, a zone is formed to disintegrate and dehumidify the initial feed in the flow; the hollow zone between the flow housing and the mentioned flywheels; a radial-type synchronous separator-dehumidifier that is capable of supplying, to a certain extent, from the working chamber to the mentioned hollow zone dried particles of the disintegrated initial feed relative to their size and humidity, where the separator-dehumidifier is mounted on at least one concave working flywheel and can be installed on each of them along various circumferences, and particles are dried in the working chamber and working zones by means of friction between each other and with air in the working chamber and in working zones; and an outlet port located in the flow housing that can discharge to the process line dried particles of the disintegrated initial feed to a certain extent, wherein the flow housing with the outlet port, the mentioned working flywheels with the mentioned synchronous separator-dehumidifier represent a single assembly with the device, where the process of taking in the initial feed into the working chamber, the process of discharging dried particles of the disintegrated initial feed into the hollow zone to a certain extent and discharging dried particles of the disintegrated initial feed into the process line through an outlet port are done by rotation of the mentioned working flywheels.

The second embodiment of this invention suggests a device for flow disintegration, dehumidification and separation of loose materials having an flow housing that comprises: two concave working flywheels comprising radial ribs on their concave surfaces, capable of counter rotation, having a gap between them, installed co-axially on a fixed hollow axis with ports to supply the initial feed or on two fixed hollow axes comprising at least one port to supply the initial feed, wherein there is a working chamber between the working surfaces of the mentioned flywheels with a space confined by the mentioned working surface where, in its turn, a zone is formed to disintegrate and dehumidify the initial feed in the flow; the hollow zone between the flow housing and the mentioned flywheels; a radial-type synchronous separator-dehumidifier that is capable of supplying, to a certain extent, from the working chamber to the mentioned hollow zone dried particles of the disintegrated initial feed relative to their size and humidity, where the separator-dehumidifier is mounted on at least one concave working flywheel and can be installed on each of them along various circumferences, and particles are dried and the initial feed is disintegrated in the working chamber and working zones by means of friction between each other and with air in the working chamber and in working zones; and an outlet port located in the flow housing that can discharge to the process line dried particles of the disintegrated initial feed to a certain extent, wherein the flow housing with the outlet port, the mentioned working flywheels with the mentioned synchronous separator-dehumidifier represent a single assembly with the device, where the process of taking in the initial feed into the working chamber, the process of discharging dried particles of the disintegrated initial feed into the hollow zone to a certain extent and discharging dried particles of the disintegrated initial feed into the process line through an outlet port are done by rotation of the mentioned working flywheels, and the disintegrator-separator of loose materials comprises three working zones: the first working zone located in the mentioned working chamber, the second working zone located in the radial-type synchronous separator-dehumidifier and the third working zone located in the hollow zone between the flow housing and the mentioned working wheels where each working zone creates its own gage pressure from −04 atm to +1 atm.

The third embodiment of this invention suggests a device for flow disintegration, dehumidification and separation of loose materials that comprises stages where: feed is supplied to the working chamber with a confined space where the confined space of the working chamber is formed by the working surfaces of two concave working flywheels; the initial feed is disintegrated and the initial disintegrated feed particles are dried to the specific level in working zones by impact reflection and/or friction of particles between each other and air; by means of the radial-type synchronous separator dehumidifier, dried particles of the initial feed are supplied, to a certain extent, from the working chamber into the hollow zone formed between the mentioned flywheels and the flow housing; dried particles of the initial feed are discharged outside to a certain extent through an outlet port located in the mentioned housing, wherein the mentioned stages of supplying the mentioned initial feed to the working chamber, disintegration of the initial feed and dehumidification of the disintegrated initial feed in the working chamber, discharging of dried particles of the initial feed to a certain extent into the hollow zone as well as discharge of particles of the disintegrated and dried initial feed into the process line through an outlet port are done by means of rotating the mentioned flywheels.

The fourth embodiment of this invention suggests a device for flow disintegration, dehumidification and separation of loose materials that comprises stages where: the initial feed is supplied to the first disintegration working zone; the initial feed is disintegrated and particles of the disintegrated initial feed are dehumidified to a certain extent; disintegrated and dried particles of the initial feed are supplied to the third working zone by means of the second working zone; disintegrated particles of the initial feed are additionally dried in the third working zone; dried particles of the disintegrated initial feed are discharged to a certain extent from the third working zone to the process line, where all the mentioned stages take place by means of the counter-rotation of two flywheels located in the housing of the device for flow disintegration, dehumidification and separation of loose materials.

The fifth embodiment of this invention suggests a device for flow disintegration, dehumidification and separation of loose materials comprising two mechanical assemblies with a working zone formed between them to disintegrate the initial feed particles where the mentioned mechanical assemblies have a contactless circular connection that limits the discharge of initial feed particles, according to the size distribution, from the disintegration working zone wherein the mechanical assemblies provide the working chamber and the cavity between the flow housing and mechanical assemblies with the air and feed flow, where this flow provides a specific degree of dehumidification of initial feed disintegrated particles, and the flow housing provides discharge of disintegrated initial feed particles and initial feed particles dried to a certain extent into the process line.

It is obvious that the previous general description and the following detailed description are given for reference and explanation only and are not restrictive of the disclosure.

### BRIEF DESCRIPTION OF THE DRAWINGS

FIG. 1 shows the general view of the device.

FIGS. 2A and 2B show a general view of the radial-type synchronous separator-dehumidifier.

FIG. 3 shows a general view of the device with the direction of air flow movement.

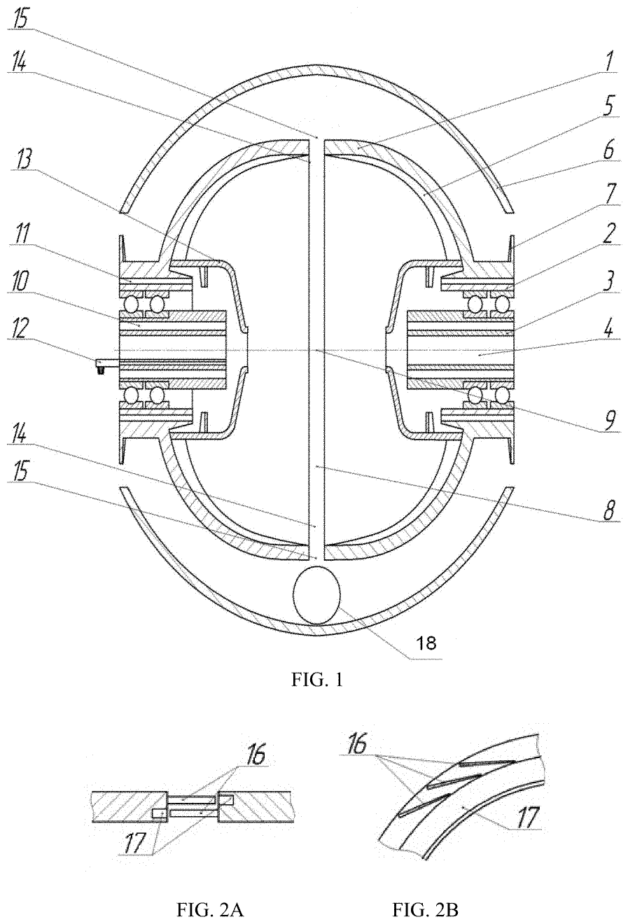

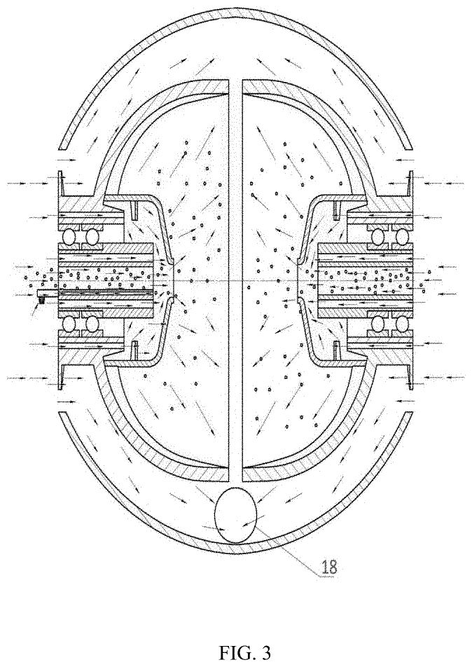

### DETAILED DESCRIPTION OF THE PREFERRED EMBODIMENT OF THE INVENTION

The claimed device operates as follows. The initial feed is supplied through a port or ports of the hollow axis that can be made with a tilt on the axis cavity surface oriented towards the working chamber. The initial feed can also be multi-component. The mentioned feed is sucked in and supplied to the working chamber where it changes its direction from axial to radial and rotates creating twisted streams of the air and feed mixture. As a result, the head-to-head collision of chunks of the initial feed takes place in the working chamber along with even destruction and dissipation along the entire volume of the working chamber. The radial-type synchronous separator-dehumidifier creates an obstacle for the initial feed particles when they exit the working chamber zone using the air stream and structural elements until it is completely disintegrated reaching ultra-fineness.

The force acting on the initial feed to be integrated is thousands times more than the resistance to destruction of chunks and particles of the initial feed due to the weight of two rotating concave working (centrifugal) flywheels acting as accumulators of kinetic energy converted into mechanical energy of disintegration. The action (including decelerating action) of the initial feed onto the flywheels is extremely low due to the energy reserve of the rotational movement of the mentioned flywheels. The weight of the mentioned flywheels by many times exceeds the weight of the initial feed in the working chamber. Additionally, the working flywheel, the fan providing air volume to the flow housing and the hub assembly form a mechanical assembly. Fans that supply air flows under the flow housing can also be installed onto the mentioned mechanical assemblies.

The actions are directional impacts, reflection and acceleration of the air and feed mixture, which are created by working elements of the mentioned flywheels. The flywheel comprises elements in the form of radial ribs that can be made curved and, if necessary, impact elements of any configuration and alloy can be installed. The specified fineness (particle size) and drying of the mentioned particles are adjusted by the rotation speed of the mentioned working flywheels. Two concave working (centrifugal) flywheels are capable of counter rotation, have a clearance between them, installed co-axially on a fixed hollow axis with ports to supply the initial feed or on two fixed hollow axes comprising at least one port to supply the initial feed, including multi-component feed. There is a working chamber formed between the mentioned wheels, which have limited space and is a zone of self-disintegration and dehumidification of initial feed particles in the flow.

A radial-type synchronous separator-dehumidifier is located on the periphery of the working chamber. The mentioned separator-dehumidifier can be made as a radial fan, a circular grid or any other element enclosing the flywheel circumference and acting as a separator-dehumidifier relative to the size and humidity of particles and impeding the discharge of disintegrated products with the required fineness and humidity. The elements of the mentioned separator can be made capable of contactless location on each other. The device provides continuous disintegration of the initial feed in the flow, separation and dehumidification of particles of the disintegrated initial feed in the flow.

The particles of the initial feed are dehumidified by going through three working zones: the first working zone located in the mentioned working chamber, the second working zone located in the radial-type synchronous separator-dehumidifier and the third working zone located in the hollow zone between the flow housing and the mentioned working wheels. Each working zone carries out individual functions. The first working zone is intended to disintegrate the initial feed and dehumidify the disintegrated initial feed. The second working zone is intended for additional dehumidification and sorting of the particles of the disintegrated initial feed. The third working zone is intended for final dehumidification of the particles of the disintegrated initial feed and to supply the finished product into the process line through an outlet port. Each working zone creates the necessary temperature inside that is sufficient for optimal dehumidification of the particles of the disintegrated initial feed, as well as its own gage pressure within −04 atm to +1 atm depending on the requirements to the initial feed in terms of composition and density.

During rotation at high speeds, the mentioned elements are heated due to friction with air and ensure temperature rise in the working zones of the device for flow disintegration and separation of loose materials. The temperature rise is reached by adjusting the clearance between the elements of the mentioned separator. The temperature depends on the shape of the pressure elements. In this case, the pressure elements are radial ribs and separator elements.

The air and feed mixture comprising air and initial feed particles is entrained into circular motion in the annular clearance between elements of the synchronous separator-dehumidifier. Disintegration in the device for flow disintegration and separation of loose materials occurs under the action of forces of impact, deflection, friction and co-impact of particles caused by the action of working chamber structural elements and interaction of counterflows of the air and feed mixture, which leads to primary cracks or further development of existing structural defects in the initial feed particles. When the front part of the particle is abruptly stopped by the hard surface of the flywheel or a particle coining from an opposite direction, the inertia forces develop significant stresses inside the particle that exceed mechanical resistance, and cracks start slowly to be formed from the point of contact along the surfaces of the least resistance and then propagate along the entire structure of the particle. When the particles of the initial feed are distanced towards the working chamber periphery, centrifugal forces are increased and cause breaking (elongating) stresses leading to the complete destruction of the initial feed. It is the centrifugal force that has the highest effect on the initial feed destruction in the claimed device.

Mechanical energy spent for disintegration, synchronous separation and dehumidification is translated from the rotation of flywheels, so that the energy consumption of the entire process is defined by pinning and maintaining the defined speed of flywheels.

The working process of disintegration, synchronous separation and dehumidification is related to the impact and wearing effects of the air and feed mixture on the device structural elements. Therefore, the working chamber elements, namely the concave surfaces of two working (centrifugal) flywheels, radial ribs, parts of the radial-type synchronous separator-dehumidifier, ports or port of the hollow axis or hollow axes, as well as hub assemblies and air and initial feed pressure and acceleration parts are made so that they are capable of being applied with wear-resistant coatings or attached with wear-resistant (abrasion-resistant, metallic ceramic, ceramic, metal polymeric, polymeric elements, etc.) hard-alloyed parts or a protective housing that protect the structure against wear and act as lining.

Additionally, the device for flow disintegration and separation of loose materials can be made capable of connection to a computer module. The computer module can be integrated into the mentioned device and capable of extraction or it can be connected to the mentioned device. In this embodiment, the computer module supplies control signals intended to control the mentioned device. Control signals are supplied to frequency converters connected with electrical drives of the mentioned device that actuate working (centrifugal) flywheels. Control signals ensure smooth speed and load adjustment for electrical drives. Using control signals, the computer module controls loads to electrical drives to protect them and can be made capable of communication with external devices. The computer module can also be made capable of connection to analyzers of various parameters and monitoring sensors located in the device for flow disintegration and separation of loose materials to meet the requirements to the fineness of initial feed particles, their dehumidification degree and other requirements applied to the disintegrated initial feed. The computer module additionally takes readings from sensors and analyzers characterizing the degree of wear, correct functioning and other parameters of various parts of the device for flow disintegration and separation of loose materials. The computer module represents a computer and comprises at least a memory element that contains software. The computer module further comprises a transceiver (communication module).

The device for flow disintegration and separation of loose materials may comprise an integrated transceiver connected with sensors and analyzers of the mentioned device and made capable of communication with the external computer module or any other external device for transmitting data characterizing the readings of sensors and analyzers of the mentioned device. The integrated transceiver may be a USB module, a wireless data reception and transmission module or any other transceiver.

Below, together with references to the drawings, is a detailed description intended to make the above aims, technical solutions and advantages of the invention more evident.

The device for flow disintegration and separation of loose materials comprises two flywheels (1) secured to hub assemblies (2) that are installed on co-axial fixed hollow axes (3) (or a single hollow axis) with ports (4) to supply the initial feed to the working chamber that has an incline on the axis cavity surface oriented towards the working chamber. Fixed hollow axes (or a single hollow axis) are installed in detachable supports. Hub assemblies (2) have pulleys taking rotational movement from engine (electrical drive) pulleys using belts or by beltless direct (or through a coupling) connection of the engine (electrical drive) shaft to one of the hub assemblies or using gears, providing the capability of using any available options for rotation.

The working wheels (working flywheels) (1) comprise a hub assembly (2) near the axis (3), a rim in the central part and an end ring on the periphery where a synchronous separator-dehumidifier of particles is installed. The hub assembly has a dynamic (mobile) part and/or a static (fixed) part connected with the hollow axis through a bearing assembly wherein the dynamic part can be implemented both towards the external race and internal race of the bearing. In this embodiment, the fixed part is an axis secured on the structural support being an integral part of the hub assembly. The dynamic or static parts are parts where the mentioned working wheels and any other dynamic elements are attached. The bearing assembly connects the static part and/or the dynamic part and a hollow axis and ensures their structural unity. Dynamic and/or static parts of hub assemblies are capable of attaching working wheels on them and driving all dynamic parts secured on them, including the mentioned wheels. The mentioned device further comprises supports for hub assemblies (not shown in the figure), electrical drives (not shown in the figure) and an flow housing (6) that are capable of being installed on both a solid frame and on a platform without rigid connection between them. The mentioned supports can be extended manually or automatically to extend the mentioned working wheels along the axis for maintenance and repair purposes. The working surface of the flywheel has radial ribs (5) (partition walls). The mentioned flow housing can be made by at least one cavity of cast design and/or include several components.

Each hub assembly has in its static or dynamic part a port with the radius Rₕ used to attach it on the hollow axis with the radius Rₐ. Each of the mentioned working wheels further comprises a port in its central part with the radius R_{w} using which it is secured to each hub assembly, wherein Rₐ<Rₕ<R_{w}. The values of Rₐ, Rₕ, R_{w} on each of the mentioned flywheels, on each hollow axis and each hub assembly can be different. For example, the first flywheel has a port in its central part with the radius R¹_{w} and is secured on the first hub assembly having in its static part or dynamic part a hole with the radius R¹ₕ that is, in its turn, secured on the first hollow axis with the radius R¹ₒ, where R¹ₐ=100 mm, R¹ₕ=110 mm, and R¹_{w}=200 mm. The second flywheel has a port in its central part with the radius R²_{w} and is secured on the second hub assembly having in its static part or dynamic part a hole with the radius R²ₕ that is, in its turn, secured on the second hollow axis with the radius R²ₒ, where R²ₐ=200 mm, R²ₕ=210 mm, and R²_{w}=300 mm. Wherein the second flywheel with the radius R²_{w}, the second hollow axis with the radius R²ₐ and the second hub assembly with the radius R²ₕ ensure a higher throughput capacity of the initial feed into the first working zone of disintegration and lower rotation speed of the mentioned second flywheel as compared to the throughput capacity and rotation speed of the mentioned first flywheel. The lower rotation speed is caused by the fact that increased-diameter bearings are used in the hub assembly bearing assembly with the increased radius. It is generally known that in case of higher diameter bearings, the rotation speed will be less than with lower diameter bearings. The device design may further provide only one hollow axis located on a single hollow axis located on a single flywheel and ensuring initial feed supply to the working chamber. In this case, elements ensuring reflection of initial feed particles are installed on the central part of the other flywheel.

The flywheels are located under the flow housing (6). External edges of flywheels accommodate fans (7) that supply air flows under the flow housing (6) for further transportation of the air and feed mixture, wherein the mentioned housing impedes the disintegrated product discharge from under the flow housing into the surrounding space beyond the process line and the air stream is ensured by means of fans or devices supplying compressed air. In case of devices supplying compressed air, the flow housing provides ports supplying air into the hollow zone or clearance between the mentioned flywheels. The working chamber (8) is formed between the flywheels. The initial feed for disintegration is supplied to the central part of the working chamber (9). To fill the air volume of the working chamber, ventilation channels (10) are provided in the walls of the fixed hollow axis as well as ventilation channels (11) in hub assemblies that may be used to remove excessive temperature from the parts of the hub assemblies. The mentioned channels are feeders of the protective housing to protect against dust the air flow pressurizer (13) secured inside the working chamber on the elements of the flywheels or hub assembly. If necessary, the compressor may also supply compressed air through the mentioned pressurizer (not shown in the figure).

To compensate the air volume inside the working chamber, at least one additional air duct is provided in the axis walls with a control valve (12). Due to the directed motion of air flows, the excessive heat is removed from the device parts (and directed to the working chamber to maintain the necessary temperature conditions of the self-disintegration medium) and hub assemblies are protected against penetration of particles of the disintegrated initial feed. To further protect hub assemblies and air and initial feed pressurization and acceleration elements of the device for flow disintegration and separation of loose materials, the mentioned device may have a protective housing.

Depending on the safety requirements to the grinding processes of any feed, various inert gases and/or mixtures of gases (such as argon, nitrogen and others) or aerosols can be supplied to the working chamber, in addition to air, to prevent and/or reduce the level of explosion and fire hazard. Depending on the requirements to grinding of various feeds, various activating gases (carbon dioxide)/aerosols can be supplied to the working chamber in addition to air, which promote accelerated grinding (destruction of the crystalline grid with the disintegration of inter-molecular bonds) and/or activation of the initial feed surface. A capability of creating a multi-component mixture can be additionally provided in the working chamber. To create a multi-component mixture, various powders are fed to the hollow axis together with the initial feed from external dispensers, which results in homogenization of the initial feed components and these powders in the working chamber. This results in a multi-component mixture.

The zone (15) of the synchronous separator-dehumidifier of particles is provided on the periphery (14) of the working chamber. An annular clearance is located between oppositely rotating flywheels on the periphery with the vanes (16) within its area or directly inside it, which are shaped as bars, impeller, plates or any other shape and used to enclose the flywheel circumference for the radial-type synchronous separator-dehumidifier. The mentioned separator and its elements in the form of vanes (16) are located along the circumference on the periphery of the working (centrifugal) flywheel and a clearance between the concave surfaces of these wheels to release particles of defined size through the area of the mentioned separator into the flow housing. The working organs of disintegration and the synchronous separator are coupled at the edge of the first working zone. The synchronous separator-dehumidifier of particles is capable of being implemented within the body of flywheels and as an individual device attached to the flywheels or a flywheel with a single organ in the mechanism of the device.

Vanes (16) of the synchronous separator-dehumidifier of particles can be installed on one of the wheels or both wheels and implemented as individual segments or circular sectors enclosing the circumference in at least one row on various circumferences of flywheels capable of contactless location of each other depending on the required performance, the fraction of the finished product, the type of initial feed and other parameters. Vanes (16) of the synchronous separator-dehumidifier of particles and annular channels (17) of each flywheel (1) can be located on different circumferences. In this manner, the vanes installed on the same flywheel can be recessed, without contacting each other, into the body of the opposite flywheel (1) or elements secured on them. The vanes (16) of the mentioned separator are capable of adjusting the tilt angle, the entrance and exit angle, the radial distance relative to the working chamber center and adjusting the depth of fitting into the annular groove (17) for efficiently using the synchronous separator-dehumidifier of particles.

The device operates as follows. Flywheels (1) attached to hub assemblies (2) rotate on a fixed structure of the axis (3) towards each other. Air and initial feed flows inside the working chamber rotate by means of, but not limited to, radial ribs (5) of flywheels. Exposed to the centrifugal force, the air is directed to the edges of (14) the flywheels. This results in a low-pressure zone (9) in the center of the working chamber, which causes air with the initial feed to be sucked from the outside into the holes (4) of the hollow axis fixed structure. In the working chamber central area (9), the flow of air and initial feed particles changes its movement direction from axial to radial, rotating around the axis and rushing to the working chamber periphery (14). The particles are then reflected by kinetic energy and pressure difference from the periphery and surfaces of the working chamber and move to the working chamber center, with that movement then repeated under the action of centrifugal forces. Due to the mentioned reflection and co-impacting of particles, the initial feed particles disintegrate into a multitude of fine particles.

There is a synchronous separator-dehumidifier of particles with components in the form of vanes (16) located in at least one row and located opposite to the annular channels (17) on at least one of the flywheels (1) along the circumference in the edge area or in the clearance between flywheels. The vanes of the synchronous separator-dehumidifier of particles can be recessed without contacting each other into annular grooves in the body of the opposite flywheel or an element secured on the flywheel. These vanes (16) can overlap each other without contact and can be adjusted by the tilt angle of entrance and exit and radial distancing relative to the working chamber center and be adjusted by the seating depth. The vanes can be made as individual parts of the synchronous separator-dehumidifier of particles and combined into a solid ring or into annular sectors capable of contactless overlapping. The initial feed and air mixture flows encounter the synchronous separator-dehumidifier of particles located at the edge or in the annular clearance between flywheels. The synchronous separator-dehumidifier vanes (16) move over different circumferences in opposite directions with clearance between them, creating air flows and capable of being their impact reflectors. In this manner, an annular area is created for synchronous separation and dehumidification relative to the fineness and humidity of disintegrated initial feed particles in the area of the working zone periphery in the annular clearance or in the area of the annular clearance for the disintegrated and dehumidified product.

The light-weight particles of the disintegrated product of the required range of sizes and shape and supplied to the zone of the synchronous separator-dehumidifier take the directed radial motion of the air flow, and heavy particles cannot be entrained into the zone of the synchronous separator-dehumidifier due to the humidity and weight, shape and size, and continue moving inside the working chamber until deep disintegration and dehumidification. As a result of disintegration and dehumidification with synchronous separation, particles of the required fineness and controlled upper limit of particle size are formed, which causes a deeper activation of the finished product and intensive homogenization of multi-component mixtures if necessary. The defined fineness of disintegration with the upper controlled limit of particle size is adjusted by the speed of the counter-rotation of flywheels with the synchronous separator-dehumidifier of particles and location of vanes or their configuration.

Disintegrated and dehumidified particles of the initial feed go through the mentioned separator, get into the hollow zone between the flow housing and the flywheels. Additionally, the flywheels can be equipped with elements on their external sides relative to the working chamber that ensure acceleration and dehumidification of the feed mixture within the third working zone. In what follows, the disintegrated and dehumidified particles of the initial feed are thrown away by the outlet port (18) from the third working zone into the process line.

Though this invention has been illustrated and described with the reference to its embodiments, the specialists in the art will understand that specific changes and modifications can be introduced into it keeping the actual scope of the invention.

What is claimed is:

1.-44. (canceled)

45. A device for continuous disintegration, drying and separation of bulk materials, having two impellers, comprising on their concave working surfaces radial ribs, configured to be counter-rotating, having a gap between each other, installed coaxially on a stationary hollow axle or on two stationary hollow axles, comprising at least one hole to feed a feedstock into a working chamber, wherein the working chamber is formed between the working surfaces of the impellers with a space limited by the working surfaces, in which, in turn, a zone for grinding the feedstock is formed, wherein the two counter-rotating concave impellers, a periphery of which is connected by a contactless ring junction, are placed in a cavity of a flow casing being a single mechanical structure with successive flow working zones.

46. The device as claimed in claim 45, wherein the flow casing is configured in a form of at least one cavity of a molded design.

47. The device as claimed in claim 45, wherein the working zones include three working zones: a first working zone, located in the working chamber, a second working zone, located in the periphery in a form of a synchronous separator-dryer with a radial operation principle, and a third working zone, located in a hollow zone between the flow casing and the impellers.

48. The device as claimed in claim 45, wherein the device additionally comprises a protective enclosure designed to protect internal elements of the device for the continuous disintegration and separation of the bulk materials, where the internal elements include at least hub units.

49. The device as claimed in claim 48, wherein each hub unit has in its static part or dynamic part a hole with a radius Rₕ, by means of which it is fixed on the hollow axle with a radius Rₐ, and each impeller has a hole in its central part with a radius Rᵢ, by means of which it is fixed on each hub unit, wherein Rₐ<Rₕ<Rᵢ.

50. The device as claimed in claim 45, wherein the contactless ring junction is configured in a form of a synchronous separator-dryer for at least one concave impeller, configured to have a contactless extension and into the body of the opposite concave impeller or into elements of the synchronous separator-dryer.

51. The device as claimed in claim 50, wherein the blades of the synchronous separator-dryer with a radial operation principle are configured in a form of separate segments or ring sectors, closing a circle.

52. The device as claimed in claim 51, wherein the blades of the synchronous separator-dryer overlap in a contactless way.

53. The device as claimed in claim 51, wherein the blades of the synchronous separator-dryer have an adjustable pitch of inlet and outlet.

54. A device for continuous disintegration, drying and separation of bulk materials, having two impellers, comprising on their concave working surfaces radial ribs, configured to be counter-rotating, having a gap between each other, installed coaxially on a stationary hollow axle or on two stationary hollow axles, comprising at least one hole to feed a feedstock into a working chamber, wherein the working chamber and is formed between the working surfaces of the said impellers with a space limited by the working surfaces, in which, in turn, a zone for grinding the feedstock is formed, wherein at least one rotating concave impeller, a periphery of which has a contactless ring extension, is placed in a cavity of a flow casing, a single mechanical structure with successive working zones, having their overpressure within −0.4 to +1 atm.

55. The device as claimed in claim 54, wherein the flow casing is configured in a form of at least one cavity of a molded design.

56. The device as claimed in claim 54, wherein the contactless ring extension of a work tool in the periphery is configured in a form of a synchronous separator-dryer for at least one concave impeller, configured to have the contactless extension into a body of the opposite concave impeller or into elements of the device.

57. The device as claimed in claim 56, wherein blades of the synchronous separator-dryer with a radial operation principle are configured in a form of separate segments or ring sectors, closing a circle.

58. The device as claimed in claim 56, wherein blades of the synchronous separator-dryer overlap in a contactless way.

59. The device as claimed in claim 56, wherein blades of the synchronous separator-dryer have an adjustable pitch of inlet and outlet.

60. A method for the continuous disintegration, drying and separation of bulk materials, comprising the following steps:
a feedstock is fed to a working chamber with a limited space, where the limited space of the working chamber is formed by working surfaces of two concave impellers;
the feedstock is ground, and particles of the ground feedstock are dried in the working zones by means of an impact reflection and a friction of the particles between themselves and with air;
the dried particles of the ground feedstockare fed by means of a synchronous separator-dryer with a radial operation principle into a hollow zone formed between the impellers and a flow casing; and
the dried particles of the ground feedstockare ejected through an outlet, located in the casing,
wherein all mentioned above steps are implemented during a rotation of the said impellers.

61. The method as claimed in claim 60, wherein at the step of the grinding the feedstock and the drying the particles of the ground feedstock, a multi-component mixture is formed by means of a homogenization, wherein the homogenization is ensured by means of feeding the mixture of various materials into a hollow axle from external batchers.

62. The method as claimed in claim 60, wherein the grinding is regulated by a rotation speed of the impellers.

63. The method as claimed in claim 60, wherein a flow the feedstock is fed into a first working zone of grinding, ground and dried to a certain extent, the ground and dried particles are fed to a third working zone by means of a second working zone, additionally dried in the third working zone and ejected from the third working zone through the outlet into a processing line.
